(19) United States
(12) Patent Application Publication
(10) Pub. No.: US 2022/0017420 A1
(43) Pub. Date: Jan. 20, 2022

(54) Use of CO2 as Water Demand Reducer in Gypsum Stucco Rehydration Mortars

(71) Applicant: Knauf Gips KG, Iphofen (DE)

(72) Inventors: Martin Halbach, Niederwerrn (DE); Giacomo Lo Moro, Santa Luce (IT)

(21) Appl. No.: 17/295,516

(22) PCT Filed: Nov. 21, 2018
(86) PCT No.: PCT/EP2018/000519

§ 371 Date: May 20, 2021

(51) Int. Cl. C04B 28/14; C04B 18/24; C04B 40/00; C04B 38/10

(52) U.S. Cl. CPC C04B 28/14; C04B 18/241; C04B 2111/0062; C04B 38/106; C04B 40/0042

(57) ABSTRACT

The present application concerns a method for the production of a gypsum article, which includes introducing a measured quantity of carbon dioxide into the process water and mixing the stucco with the thus treated water. The CO₂-enriched water has the advantage of providing compositions with sufficient processing properties at considerably lower water contents, thus allowing for significant energy savings. The invention also concerns slurries prepared according to this method as well as an apparatus which is adapted to implement this method.

### CROSS-REFERENCE TO RELATED APPLICATION

This application is the United States national phase of International Application No. PCT/EP2018/000519 filed Nov. 21, 2018, the disclosure of which is hereby incorporated by reference in its entirety.

### BACKGROUND OF THE INVENTION

### Field of the Invention

The present application concerns a method for the reduction of the water demand of stucco slurries, which comprises introducing a weighted quantity a carbon dioxide into the process water and mixing said stucco with the thus treated water to produce a slurry. The present application is further concerned with stucco and water mixtures prepared according to this method as well as an apparatus adapted for the preparation of corresponding stucco and water mixtures.

### Description of Related Art

In the preparation of plasterboards water and stucco (consisting basically of β-calcium sulphate hemihydrate) are mixed to provide a slurry wherein this slurry is subsequently applied onto a liner, covered by a second liner and dried to provide corresponding plasterboards. To provide a uniform distribution of the gypsum as well as a lightweight construction, foam may be introduced into the mixture.

During the preparation of the board, at least part of the water, which is used for the formation of the gypsum slurry, is absorbed in the calcium sulphate hemihydrate to form calcium sulphate dihydrate. However, in order to provide sufficient fluidity and a low viscosity of the mixture it is necessary to prepare the mixture with more water than is stoichiometrically necessary to set the hemihydrate; this water then has to be removed in a drying step which results in significant energy costs for the final drying of the boards.

Since the energy required for this drying step is strongly associated to the amount of water used for the preparation of the stucco/water mixtures, there is a need for processes wherein the amount of water necessary for the formation of a mixture with adequate processability can be minimized.

EP 0 077 373 describes a process for the treatment of a calcium sulphate hemihydrate to reduce its water demand to provide a reduced healing time for the treated hemihydrate to be hydrated, wherein the stucco is combined with an about 0.01 to 5 molar aqueous solution of a gypsum solubilizing agent and the mixture thereof is blended and allowed to heal. As possible gypsum solubilizing agents, EP 0 077 373 suggests alkali and alkaline earth metal hydroxides as well as acidic or alkaline salts including carbonates. In the Examples of EP 0 077 373 it was demonstrated, that the incorporation of sodium hydroxide as a gypsum solubilizing agent notably reduces the amount of water to be evaporated from plasterboards thus prepared.

WO 2006/138001 A2 relates to a method of producing a slurry wherein a polycarboxylate dispersant, a modifier and a hydraulic material is incorporated into the slurry. The modifiers, which are specified as salts including silicates and carbonates, are said to increase the efficacy of the dispersant, which then allows for a reduction of water in the compositions. Similarly, EP 1 907 334 describes slurries comprising a dispersing agent and a modifier selected from, for example lime, concrete, silicates, phosphates, phosphonates and carbonates, wherein the modifier increases the effectivity of the dispersing agent.

Based on the above, there is a demand for a method which allows for reducing the water necessary to provide a slurry with adequate processing properties compared to the state of the art.

### SUMMARY OF THE INVENTION

In the investigations underlying this invention, it has unexpectedly been discovered that the introduction of a weighted or measured quantity of CO₂ into the process water prior to mixing the process water with the stucco powder increases the slurry fluidity and provides a volume increase, which in turn allows for a reduction of the amount of the overall process water. In addition, when the slurry is mixed with a foam, the amount of a foaming agent can be reduced as well, thus providing further economic advantages. The amount of foaming agent necessary to achieve a given density of the slurry is lower if the process water contains CO₂.

Thus, according to a first aspect, the present invention concerns a method for producing a gypsum article, comprising the production of a stucco slurry with a reduced water demand, by introducing a measured quantity of carbon dioxide into the process water and mixing the stucco with the thus treated process water.

The use of carbon dioxide as an additive to stucco and water mixtures has previously been suggested in the art as a means to increase the setting time of a stucco slurry and to simultaneously increase durability of the finished product. The addition of CO₂ to the slurry allows for larger quantities of water, for example two volumes of water on one volume of calcined gypsum, see U.S. Pat. No. 1,620,915, to be used. The increased amount of water is described as favourable because it reduces the risk of spoiling (non-setting or rotting) the slurry which was a major problem. The intention of our invention, however, is the exact opposite of this idea. We use carbon dioxide for reducing the water demand of stucco slurries. Further, according to U.S. Pat. No. 1,620,915 the carbon dioxide is added to the mixture of stucco and water, whereas according to the invention the stucco is mixed with process water having carbon dioxide dissolved or dispersed therein.

With regard to the means by which the measured quantity of carbon dioxide is introduced into the water, the present application is not subject to any relevant restrictions. For example, a very easy way to introduce carbon dioxide into the process water is simply by dispersing the CO₂ in water (possibly with application of pressure) so that the carbon dioxide dissolves at least in part in the process water. Alternatively, it is also possible to incorporate the carbon dioxide into the process water by in-situ-formation from a carbonate- or bicarbonate-precursor to which an acid is added, thus converting the carbonate to carbonic acid and/or carbon dioxide. However, introducing carbon dioxide into the water via salt precursors has the potential disadvantage that by-products from the acid-base reaction (organic or inorganic salts) are formed. Thus, by using this alternative, it cannot be ruled out that these by-products negatively affect the later hydration process of the stucco or the quality of the final product. Therefore, in the context of the present application, the introduction of a measured quantity of carbon dioxide into the process water is preferably accomplished by introducing gaseous carbon dioxide directly into water.

The use of gaseous carbon dioxide has the added advantage that this material is produced by all heating systems that burn fossil fuels and is regularly discarded in the exhaust fume emission. Considering the fact, that CO₂-emissions are becoming more and more subject to strict regulations and reduction plans (emission trading), its internal recovery provides considerable economic advantages and a more sustainable operation. Since plasterboards, as explained above, require a considerable amount of energy for their final drying which is usually generated by a plant which at the same time produces significant quantities of carbon dioxide, gaseous carbon dioxide is usually available in abundance at very low cost.

The terms “stucco slurry” and “mixture containing stucco and water” are used interchangeably in this description and have the same meaning.

Concerning the amount of carbon dioxide to be introduced into water, the present invention is not subject to any relevant restrictions except that the amount of carbon dioxide should be sufficiently high to provide an observable effect in terms of an increase of slurry fluidity relative to an identical mixture without added carbon dioxide. In the present application, it is nonetheless preferred, that carbon dioxide is introduced into the process water to provide a concentration of dissolved/dispersed carbon dioxide in the process water of at least 1 g/L, more preferably of at least 1.5 g/L and even more preferably of at least 1.8 g/L. The maximum amount of dissolved/dispersed carbon dioxide is preferably not more than 15 g/L, more preferably not more than 10 g/L and even more preferably not more than 8 g/L. It has been observed that if the carbon dioxide amount exceeds about 8 g/l, the dissolved carbon dioxide to some extent retards the setting of the calcium sulphate hemihydrate so that higher CO₂-concentrations are less preferred. In addition, if the carbon dioxide concentration in the process water is less than 1 g/L, the water reduction achievable while producing a slurry with adequate processing properties is comparatively low.

In addition, in the method according to the invention it is preferred that the water having the carbon dioxide introduced therein exhibits a pH of 8.0 or less.

In addition, it is preferred in the practice of the present invention that the stucco mixed with the process water having the carbon dioxide introduced therein to provide a water/stucco ratio in the range of about 0.5 to 1.2, preferably about 0.6 to 1.0, more preferably about 0.65 to 0.8, and even more preferably about 0.65 to 0.7. Within these ranges, regularly a good balance of water reduction and sufficiently fast setting and drying of the mixture is ensured.

The stucco in the practice of the invention may be constituted of substantially pure calcium sulphate hemi-hydrate (i.e. 98 wt.-% or more) or may comprise other calcium sulphate modifications such as anhydrous calcium sulphate or calcium sulphate dihydrate. In addition, the stucco, next to unavoidable impurities therein, may comprise other inorganic constituents, such as clays, carbonates, silicates and so on. It is preferred however that the stucco is constituted at least of 70 wt.-% of calcium sulphate hemi-hydrate, more preferably at least 80 wt.-% of calcium sulphate hemi-hydrate and even more preferably at least 90 wt.-% of calcium sulphate hemi-hydrate.

Depending on the purpose to which the mixture of stucco and water is subsequently applied, it is possible to add enforcing materials and additives which are conventional in the art of the production of gypsum articles or plasterboards. For example, it is possible to add a fibrous material such as, e.g. paper pulp, or conventional additives such as liquefiers, silicon oil, foaming agents, accelerators, refractory materials etc. to adjust the final properties of the resulting mixture. According to the inventive method, it is preferred that such enforcing materials and/or additives, if they are fed into the process water, are inserted with due distance to the CO₂ addition in order to avoid an irregular distribution of these materials. The added CO₂ should preferably have had enough time to disperse homogeneously throughout the process water before or after other additives are added. Otherwise, it is of course also possible to add the additional materials, as for example foam, directly to the mixer or into the transition of the mixer to the boot or into the boot of the mixer.

For the preparation of lightweight gypsum articles, the introduction of a foam into the slurry has proven effective and is regularly employed when producing plasterboards. Therefore, in the practice of the present invention the method preferably comprises a step wherein a foam is added to the process water and stucco mixture.

Furthermore, it is preferred that the method of the invention comprises a step, wherein an article is formed from the mixture comprising at least stucco and carbon dioxide containing process water.

The article is not the subject to any relevant restrictions concerning its shape, i.e., it is possible to form all sorts of shapes with the gypsum slurry. Preferred articles for the preparation according to the invention are plasterboards.

In addition, it is preferred in the practice of the invention that the article is dried in a step following its shaping so that the preferred method of the invention further comprises a step of drying the article or plasterboard.

In a further aspect, the present application concerns a stucco and process water mixture prepared according to the method as described above.

### BRIEF DESCRIPTION OF THE DRAWING

FIG. 1 illustrates an apparatus for preparing an article, according to the invention.

### DETAILED DESCRIPTION OF THE INVENTION

The present invention concerns an apparatus for preparing a slurry comprising stucco and process water, wherein means 1, allowing the directed introduction of carbon dioxide into the process water, is provided upstream of a mixer, in which the process water is mixed with the stucco.

The means 1 above is preferably fitted with an appropriate device to finely disperse the carbon dioxide in the process water and which provides a contact surface as large as possible for the carbon dioxide with the water into which the carbon dioxide is introduced. Preferably, the means comprises a sparger 2 to introduce the carbon dioxide into the water.

The mixer 4 allows for the blending of carbon dioxide enriched process water and the stucco. In addition, the inventive apparatus preferably has means 6 to feed a foam stream into the mixer 4 or into a line 10, by which the slurry is fed to the conveyor 12.

With respect to the distance between the means 1 and the mixer 4, the distance should regularly be such that the dissolution or “dispersion” of the carbon dioxide into the process water is stably formed to avoid or reduce devolatilization and loss of the carbon dioxide during the process water/stucco mixing process. Evidently, this distance depends on the process parameters (i.e. how much carbon dioxide is incorporated, the temperature, the speed by which the water moves in the lines, etc.), but the positioning of the mixer 4 at an appropriate distance will not confront the skilled practitioner with particular difficulties.

If the apparatus is constructed with inlets (7a, 7b, etc.) for additives or strengthening materials such as paper fibers, these inlets are preferably added to the line 5 at a position, where the carbon dioxide has already been introduced into the water, i.e. downstream of the means 1. Therefore, the apparatus may have inlets (7a, 7b, etc.) by which fibrous materials and additives are introduced into the line 5. It is further preferred that the inlets (7a, 7b, etc.) for fibrous materials and additives are at positions sufficiently far removed from the carbon dioxide introduction site of means 1 into the process water so as to ensure a sufficiently stable gas/liquid dispersion at the point in time, where the fibrous materials and/or additives are introduced.

In addition, it is preferred that the inventive apparatus comprises a forming means by which the process water/stucco mixture produced in mixer 4 is formed into the desired shape. The forming means may be a continuous forming means such as a moving conveyor equipped with a forming station or a discontinuous forming means such as a mould into which a respective quantity of process water/stucco mixture is introduced.

As indicated above, preferred products of the present invention are plasterboards. Therefore, in a preferred aspect of the present application, the apparatus comprises a dispensing means 9 which is shaped to dispense a continuous layer of the slurry onto a liner, for example a cellulose based fibrous material 11a or a fiber mat. The slurry layer thus applied to the liner will be covered by second liner 11b. The apparatus preferably in addition has a conveyor 12 to convey the layers of liner material concurrent with the dispense of the slurry there between. The layers of liner materials are preferably paper or paper-board layers or woven or non-woven mat comprising glass or mineral or polymer fibers or a mixture thereof.

Furthermore, it is preferred in the context of the present application that the apparatus comprises a dryer 13 downstream of the forming means.

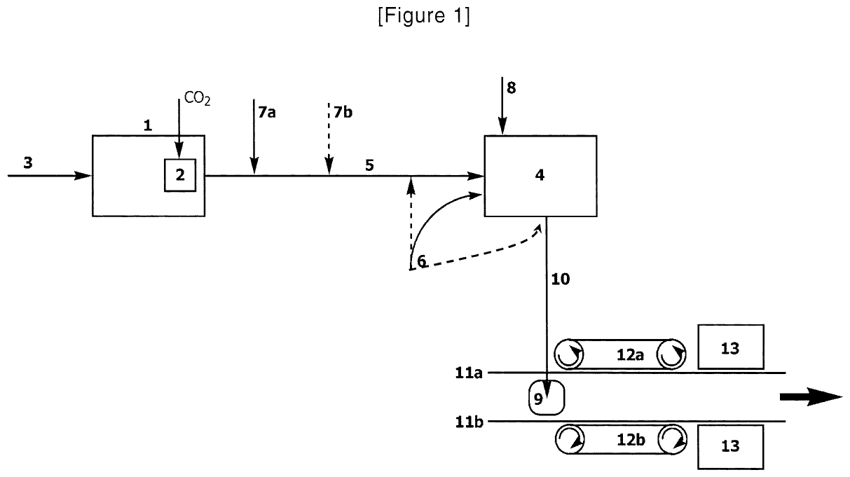

Referring to FIG. 1, an apparatus is depicted, wherein process water is fed via line 3 to a carbon dioxide introduction means 1 which is fitted with a sparger 2. After the carbon dioxide has been introduced into the process water, the process water is passed through line 5 which has inlets for additives 7a and for fibrous materials 7b. Further an inlet for foam 6 can be provided. Via line 5, the process water is transferred into a mixer 4 which has an inlet 8 for the addition of stucco and may optionally also have an inlet for foam 6. Once the stucco and the process water have been thoroughly mixed in the mixer, they are passed to a dispensing means 9 via line 10 by which the mixture is dispensed onto a liner 11b and subsequently covered by an additional liner 11a. These layers are continuously conveyed in the direction depicted by the arrow by means of the conveyor 12. After the stucco process water mixture has been dispensed onto the first liner and covered by the second liner, the structure thus formed is passed through a forming station, cut to size and dried in a dryer 13 to drive off the excess water still contained in the board.

The invention will be further described by way of examples, which are, however, only to be understood as an illustration of the invention and not in any way as limiting.

### Example 1

Different amounts of gaseous CO₂ were introduced into water prior to mixing with a stucco powder. The amount of water in each case was adjusted such that substantially identical processing properties such as fluidity/viscosity were obtained. The fluidity of a slurry was determined according the dispersal method as described prEN 1379-2:2014 was kept a constant. The amount of water necessary to achieve the given fluidity was recorded. The results of this test are provided in the following Table 1.

TABLE 1

| CO₂ incorporated | Ratio of water added | Water reduction potential |
|---|---|---|
| [g/L] | [g/g] | [%] |
| 0 | 0.725 | |
| 1.2 | 0.701 | 3.3 |
| 1.8 | 0.694 | 4.3 |
| 5.1 | 0.675 | 6.9 |

Table 1 lists the concentration of CO₂ added to the water, the amount of water with reference to the applied amount of stucco necessary to reach a given fluidity and the achieved water reduction with respect to the reference. It shows that with increasing amounts of a carbon dioxide, a significant reduction in the water necessary for the preparation of the slurry was possible although the fluidity was maintained on the same level. The highest water reduction of about 7% was obtained with about 5 g/L CO₂. At about 5 g/L CO₂ addition a moderate retarding of the slurry stiffening is observed. Thus, taking the retarding effect into account no more than 15 g/L CO₂, preferably no more than 8 g/L CO₂ should be incorporated into the slurry.

A water reduction of 3.3 and 4.3% in a regular processing line translates into energy savings of about 0.8 and 0.12 kWh/m², respectively. For the 5% CO₂-containing water, the energy savings would be about 0.2 kWh per square meter of produced boards.

Furthermore, it was observed that the board prepared at a concentration of 1.8 g/L CO₂ allowed for a reduction of 3% of the foaming agent and to provide nevertheless about the same characteristics as the composition prepared with water containing no carbon dioxide.

Taking into consideration the fact that plasterboard plants usually produce several million of m² of plasterboards per year the possible savings in energy and foaming agent add up to substantial amounts.

1. A method for producing a gypsum article, wherein the method comprises introducing a measured quantity of carbon dioxide into a process water and mixing stucco with the thus treated process water to form a slurry, wherein the addition of carbon dioxide to the process water results in a reduction of the amount of process water necessary to achieve a given fluidity of the slurry.

2. The method according to claim 1, wherein the amount of carbon dioxide introduced into the process water provides a concentration of dissolved/dispersed carbon dioxide of at least 1 g/L, preferably at least 1.5 g/L or at least 1.8 g/L but no more than 15 g/L, preferably no more than 10 g/L or no more than 8 g/L.

3. The method according to claim 1, wherein the process water having the carbon dioxide introduced therein exhibits a pH of 8.0 or less.

4. The method according to claim 1, wherein the stucco is mixed with the process water having the carbon dioxide introduced therein to provide a water/stucco ratio in the range of about 0.5 to 1.2, preferably about 0.6 to 1.0, more preferably about 0.65 to 0.8.

5. The method according to claim 1, wherein prior to the mixing of the stucco with the carbon dioxide containing process-water paper pulp or additives are fed into the carbon dioxide containing water.

6. The method according to claim 1, wherein a foam is mixed with the slurry, and wherein the addition of carbon dioxide to the process water results in a reduction of the amount of foaming agent necessary to achieve a given density of the slurry.

7. The method according to claim 1, wherein the mixture containing stucco and carbon dioxide containing process water is formed to an article, preferably a building board, especially a plasterboard.

8. The method according to claim 7, further comprising a step of drying the article or plasterboard.

9. A slurry prepared from a water/stucco mixture prepared according to the method of claim 1.

10. An apparatus for preparing a slurry comprising a mixture of at least stucco and process water, wherein means are provided upstream of a mixer in which the stucco is mixed with the process water, wherein the means 1 allow for the directed introduction of carbon dioxide into the process water.

11. The apparatus according to claim 10, wherein the means, by which the carbon dioxide is introduced into the process water, comprises a sparger.

12. The apparatus according to claim 10, further comprising a mixer to mix the carbon dioxide enriched water with the stucco and preferably a means to feed a foam into the mixer or into a line, by which the slurry fed to the conveyor.

13. The apparatus according to claim 10, further comprising a forming means, by which the water/stucco mixture produced in mixer is formed into a desired shape.

14. The apparatus according to claim 10, wherein the forming means comprises a dispenser which applies a continuous layer of the slurry onto a liner.

15. The apparatus according to claim 13, further comprising a dryer downstream of the forming means.
